(19) United States
(12) Patent Application Publication
(10) Pub. No.: US 2011/0303109 A1
(43) Pub. Date: Dec. 15, 2011

(54) FLEXOGRAPHIC PRINTING HEAD

(75) Inventors: Vittorio Ferrari, Reggio Emilia (IT); Milo Campioli, Reggio Emilia (IT)

(73) Assignee: OMSO DECOMAC - SOCIETA' A RESPONSABILITA' LIMITATA, Reggio Emilia (IT)

(21) Appl. No.: 12/815,559

(22) Filed: Jun. 15, 2010

(30) Foreign Application Priority Data
Jun. 15, 2010 (IT) RE2009A000059

(51) Int. Cl. B41F 13/10

(52) U.S. Cl. 101/376

(57) ABSTRACT

A printing head for flexographic printing on thin-walled objects not exhibiting a perfectly smooth surface, the printing head comprising an inking roller, which rotates on contact with a flexographic printing plate borne on a printing plate bearing roller, in which the printing head comprises a roller bearing a transfer surface which rotates on coming into contact with the printing plate, the transfer surface being a perfectly smooth and faultless surface and being made of a material that is more yielding than a material of which the flexographic printing plate is made.

The invention relates to machines for printing on generally cylindrical objects using a system generically known as flexographic. In this type of machines the objects are rotated in direct contact with a cylindrical printing matrix.

The figure to be printed is configured in relief on the printing plate which is applied on a cylindrical roller, known as a printing roller, which rotates in contact with an inking roller, known as the anilox roller.

It is commonly known that the printing matrix, also known as flexographic printing form, is made of synthetic material such as a polymer. The anilox roller transfers the ink drawn from a reservoir to the parts in relief of the flexographic printing plate, which then transfers the ink onto the surface to be printed upon.

This type of machine comprises at least one rotating chuck the function of which is to bring the surface to be printed on into contact with the flexographic printing plate.

The flexographic printing plate is generally located in a stationary printing station, whereas the chuck is one of a plurality of chucks borne radially, in equidistant positions, by a rotating platform called a carousel which step-advances, bringing the chucks into the printing station one by one in succession.

The carousel can serve more than one printing station, one for each colour of the figure to be printed.

In the line of contact between the surface and the flexographic printing plate the velocities of the surface to be printed and of the flexographic printing plate have to be absolutely identical in order to avoid dragging which would cause smudges and poor printing quality.

However, it happens that with very slim objects which do not have a perfectly smooth surface, such as small heat-formed containers, the printing reveals small faults essentially due to the imperfect contact between the matrix and the surface to be printed.

These contact imperfections are due to the, albeit minimal, deformations of the flexographic printing plate caused by the printing pressure.

These deformations tend to appear near the lines that separate the parts in relief of the matrix and the normal flat surface.

When the figure to be printed comprises a thin line, or a small point, the flexographic printing plate comprises a corresponding thin relief, in form of a thin crest, or peak or rib.

Under the printing pressure, said peak, crest or rib tend to bend, offering a distorted surface to the printing surface, and therefore giving rise to a printing fault.

For this reason the flexographic printing plate has to be made of a sufficiently rigid material, but this is often not enough for eliminating the contact defects with the surface of the object to be printed.

The aim of the invention is to obviate the above-mentioned drawbacks in the ambit of a simple, realtively-inexpensive and reliable construction.

The aim is attained by the invention, which provides a printing device having the characteristics as recited in the independent claim.

Generally speaking, according to the invention, between the flexographic printing plate and the printing surface a transfer roller is provided, which receives the image from the flexographic printing plate and transfer the image to the printing surface.

The transfer roller has a perfectly smooth and faultless transfer surface and is made of a material that is more yielding than the material of which the printing plate is made.

By consequence the printing pressure will occur between the printing plate and the transfer surface, which will deform more and more easily that the printing plate preventing any local deformation thereof.

Further useful and advantageous characteristics of the invention are set out in the dependent claims.

The advantageous constructional and functional characteristics of the invention will emerge from the detailed description that follows, illustrated in the figures of the accompanying tables of drawings and relating to a preferred embodiment of the invention, given by way of non-limiting example.

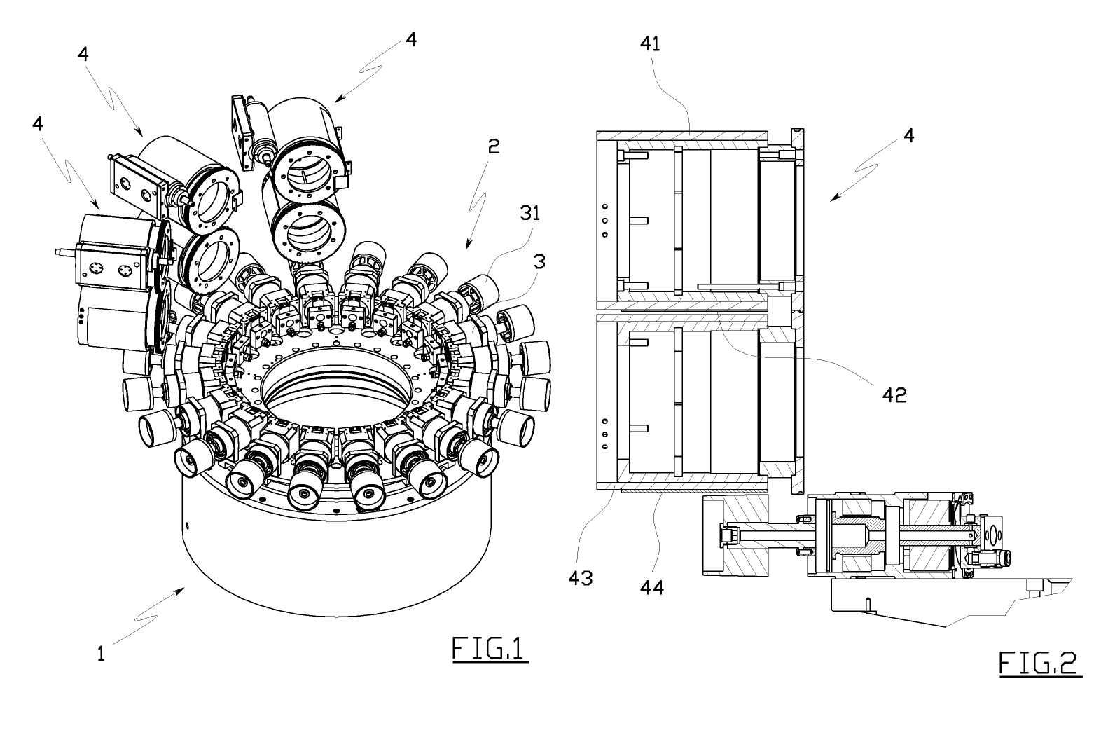

FIG. 1 schematically shows a printing machine according to the invention in perspective view.

FIG. 2 schematically shows a section of FIG. 1 in the printing station plane.

FIG. 3 shows a view in larger scale of a printing station.

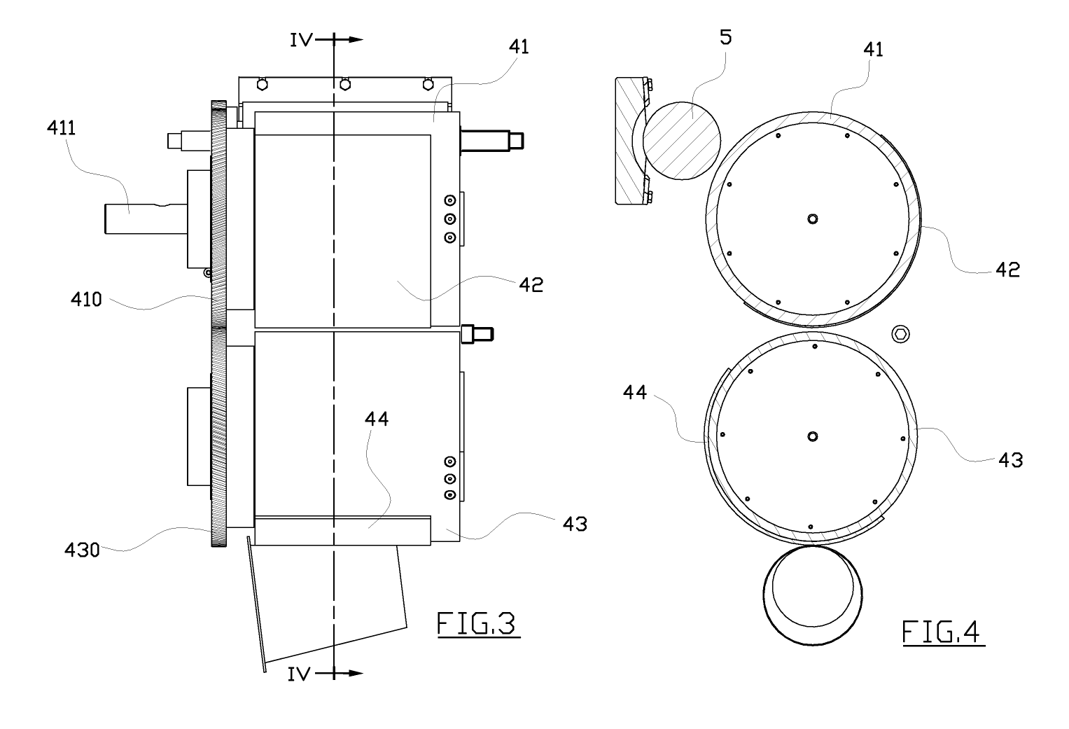

FIG. 4 shows section IV-IV of FIG. 3.

The above figures illustrate a printing machine 1 comprising a carousel 2 exhibiting a plurality of object-bearing chucks 3.

The characteristics of the carousel and of the chucks are well known to experts in the sector and are therefore not described in detail.

The structure of the machine, not illustrated, bears three printing heads 4 located in succession.

Each of the heads 4 comprises a structure, not illustrated, which bears a plate bearing roller 41 upon which a which a-flexographic printing plate 42, of known type, is fitted.

The form-bearing roller 41 is rotated by a motor, not illustrated, connected to a shaft 411 of the roller 41 by means of an appropriate transmission.

During the rotation of the roller 41 the flexographic printing plate 42 comes into contact with an inking roller, or anilox roller 5 having known characteristics and being also supported by the structure of the printing head. A roller 43 bearing a transfer surface 44 made of a more yielding material than that of the flexographic printing plate, such as rubber, is located below the form-bearing roller 41; the extension of the transfer surface is at least equal to that of the flexographic printing plate.

The transfer surface is absolutely smooth and is free of imperfections and surface irregularities.

In the illustrated example, the rollers 41 and 43 are coupled by a pair of gears 410 and 430, which rotate the rollers in opposite directions to one another, at exactly the same velocity.

Obviously, other means for coupling can be used.

The thickness of the flexographic printing plate and the thickness of the transfer surface, like the diameter of the rollers 41 and 43, are such that the flexographic printing plate and the transfer surface come into reciprocal contact without dragging.

One of the chucks 3 bearing the object to be printed upon 31 is cyclically brought into position below the roller 43 such as to place the surface of the object tangentially with respect to the surface of the transfer surface, with a suitable printing pressure.

The rotations of the chuck are subject to the rotations of the flexographic printing plate thanks to control devices that guarantee reciprocal synchronization in terms of both velocity and running-and-stopping time.

These devices can be either mechanical or electrical, and are well-known to experts in the sector; therefore they are not described in detail here.

With regard to the electrical devices, they are easily deducible from the description of Italian patent application PR2003A000015.

The distance between the two rollers 41 and 43 is adjustable such that the flexographic printing plate and the transfer surface are brought into contact with a pressure that is the same as that of the printing pressure, so that the resulting image on the matrix is transferred without faults onto the perfectly smooth surface of the transfer surface; this is attained thanks to the yielding nature of the transfer surface which prevents deformations of the matrix near the lines that separate the areas in relief from the underlying flat surface.

The image gathered by the transfer surface, which as mentioned herein above is perfectly smooth and without surface faults, is then faultlessly transferred onto the object to be printed upon.

The small deformations of the transfer surface due to the printing pressure exerted by the surface to be printed upon are in fact uniformly distributed over its surface, and cause non-localized and acceptable distortions of the image.

The yielding nature of the transfer surface guarantees a perfect contact with the object to be printed upon also when the object exhibits surface faults. All the aims of the invention are therefore attained; obviosuly the solution herein described can be modified and perfected without its forsaking the ambit of the following claims.

1. A printing head for flexographic printing on thin-walled objects not exhibiting a perfectly smooth surface, the printing head comprising an inking roller, which rotates on contact with a flexographic printing plate borne on a printing plate bearing roller, characterized in that the printing head comprises a roller bearing a transfer surface which rotates on coming into contact with the printing plate, the transfer surface being a perfectly smooth and faultless surface and being made of a material that is more yielding than a material of which the flexographic printing plate is made.

2. The printing head of claim 1, characterized in that the transfer surface is made of rubber.

3. The printing head of claim 1, characterized in that the flexographic printing plate bearing roller (41) and the transfer surface roller (43) are reciprocally coupled by means causing the flexographic printing plate bearing roller (41) and the transfer surface bearing roller (43) to rotate in reciprocally-opposite directions at an identical velocity.

4. The printing head for the flexographic printing of objects of claim 3, characterized in that the devices rotating the rollers in reciprocally-opposite directions and at the identical velocity comprise a pair of gears.
